(19) United States
(12) Patent Application Publication
(10) Pub. No.: US 2024/0187664 A1
(43) Pub. Date: Jun. 6, 2024

(54) MAIN PART GENERATION DEVICE, MAIN PART GENERATION METHOD, AND NON-TRANSITORY COMPUTER-READABLE MEDIUM

(71) Applicant: NEC Corporation, Minato-ku, Tokyo (JP)

(72) Inventors: Yasubumi HONMA, Tokyo (JP); Kazuaki SAITO, Tokyo (JP); Fuyuki MATSUURA, Tokyo (JP); Nanami TANOUE, Tokyo (JP)

(73) Assignee: NEC Corporation, Minato-ku, Tokyo (JP)

(21) Appl. No.: 18/284,998

(22) PCT Filed: Apr. 8, 2021
(86) PCT No.: PCT/JP2021/014887

§ 371 Date: Sep. 29, 2023

(51) Int. Cl. H04N 21/238

(52) U.S. Cl. CPC H04N 21/238

(57) ABSTRACT

A main part generation device of the present disclosure includes main part generation condition acquiring means, viewing data acquiring means, moving image content acquiring means, and main part generating means. The main part generation condition acquiring means acquires main part generation condition data indicating generation conditions for a main part program of a broadcast station. The viewing data acquiring means acquires viewing-related data of a viewer from a terminal device with which the viewer views main part moving image content. The moving image content acquiring means acquires a plurality of pieces of moving image content. Based on the viewing-related data and the main part generation condition data, the main part generating means combines the moving image content to generate the main part moving image content to be distributed to the viewer.

### TECHNICAL FIELD

The present invention relates to a main part generation device, a main part generation method, and a non-transitory computer-readable medium.

### BACKGROUND ART

In the case of a location program, program product requires many production processes such as securing of coverage staff, research of a coverage place, filming on the day, and editing of a video material after location, and personnel relating thereto. In the program production process, many staff members and equipment are involved and it is difficult for anyone to easily perform program production. Here, various techniques for easily producing a program are disclosed.

For example, Patent Literature 1 discloses a technique for combining a plurality of pieces of content to organize a program to be broadcast to a user. Patent Literature 2 discloses a technique for selecting content such as video that matches a preference condition of a user and assembling a program to be broadcast to the user according to the selected content.

### CITATION LIST

### Patent Literature

Patent Literature 1: Japanese Unexamined Patent Application Publication No. 2002-354383
Patent Literature 2: Japanese Unexamined Patent Application Publication No. 2003-061071

### SUMMARY OF INVENTION

### Technical Problem

In Patent Literature 1 and Patent Literature 2, although the preference condition of the user is reflected on the program to be broadcast, there is a problem that it is difficult to reflect requirements on a program broadcast side such as requirements of a broadcast station on the production of the program.

In view of such a problem, an object of the present disclosure is to provide a main part generation device, a main part generation method, and a non-transitory computer-readable medium that can reflect requirements on a program broadcast side on production of the program.

### Solution to Problem

A main part generation device of the present disclosure includes: main part generation condition acquiring means for acquiring main part generation condition data indicating a generation condition for a main part program of a broadcast station; viewing data acquiring means for acquiring viewing-related data of a viewer from a terminal device with which the viewer views main part moving image content: moving image acquiring means for acquiring a plurality of pieces of moving image content: and main part generating means for combining the moving image content based on the viewing-related data and the main part generation condition data to generate main part moving image content to be distributed to the viewer.

A main part generation method of the present disclosure includes: acquiring main part generation condition data indicating a generation condition for a main part program of a broadcast station: acquiring viewing-related data of a viewer from a terminal device with which the viewer views main part moving image content; acquiring a plurality of pieces of moving image content: and combining the moving image content based on the viewing-related data and the main part generation condition data to generate main part moving image content to be distributed to the viewer.

A non-transitory computer-readable medium of the present disclosure stores a program for causing a computer to execute processing for: acquiring main part generation condition data indicating a generation condition for a main part program of a broadcast station: acquiring viewing-related data of a viewer from a terminal device with which the viewer views main part moving image content; acquiring a plurality of pieces of moving image content: and combining the moving image content based on the viewing-related data and the main part generation condition data to generate main part moving image content to be distributed to the viewer.

### Advantageous Effects of Invention

According to the present disclosure, it is possible to provide a main part generation device, a main part generation method, and a non-transitory computer-readable medium that can reflect requirements on a program broadcast side on production of the program.

### BRIEF DESCRIPTION OF DRAWINGS

FIG. 1 is a block diagram illustrating a configuration of a main part generation device according to a first example embodiment.

FIG. 2 is a block diagram illustrating a configuration of a broadcast system according to second, third, and fourth example embodiments.

FIG. 3 is a block diagram illustrating a configuration of a main part generation device according to the second example embodiment:

FIG. 4 is a schematic diagram illustrating an operation of a viewing data collection device according to the second example embodiment.

FIG. 5 is a flowchart illustrating an operation of the main part generation device according to the second example embodiment.

FIG. 6 is a schematic diagram illustrating an operation of a contribution reception device according to the second example embodiment.

FIG. 7 is a diagram illustrating an example of main part moving image content according to the second example embodiment.

FIG. 8 is a block diagram illustrating a configuration of a main part generation device according to the third example embodiment.

FIG. 9 is a flowchart illustrating an operation of the main part generation device according to the third example embodiment.

FIG. 10 is a block diagram illustrating a configuration of a main part generation device according to the fourth example embodiment.

FIG. 11 is a flowchart illustrating an operation of the main part generation device according to the fourth example embodiment.

FIG. 12 is a block diagram illustrating a configuration of a computer according to an example embodiment.

### EXAMPLE EMBODIMENT

Example embodiments of the present disclosure are explained in detail below with reference to the drawings. In the drawings, the same or corresponding elements are denoted by the same reference numerals and signs and redundant explanation of the elements is omitted according to necessity for clarity of explanation.

“Content” indicates, for example, a video, a streaming moving image program with voice, or a VOD (Video On Demand) moving image program. In the present disclosure, “content” mainly refers to a streaming moving image program.

### First Example Embodiment

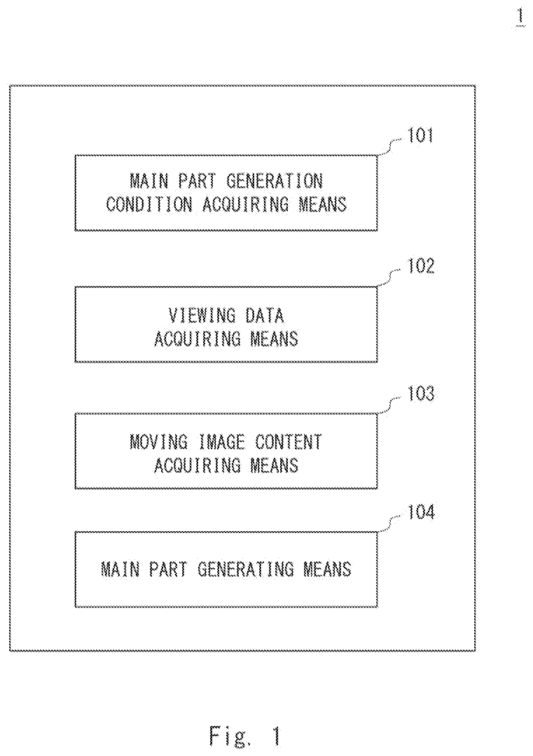

First, a configuration of a main part generation device 1 according to a first example embodiment is explained with reference to FIG. 1. The main part generation device 1 includes main part generation condition acquiring means 101, viewing data acquiring means 102, moving image content acquiring means 103, and main part generating means 104.

The main part generation condition acquiring means 101 acquires main part generation condition data indicating generation conditions for a main part program of a broadcast station. The viewing data acquiring means 102 acquires viewing-related data of a viewer from a terminal device with which the viewer views main part moving image content. The moving image content acquiring means 103 acquires a plurality of pieces of moving image content. Based on the viewing-related data and the main part generation condition data, the main part generating means 104 combines the moving image content to generate a main part moving image content to be distributed to the viewer.

Therefore, the main part generation device 1 according to the first example embodiment can reflect requirements on a program broadcast side such as requirements of a broadcast station on production of a program. The main part generation device 1 can reflect information concerning the viewer on the production of the program.

### Second Example Embodiment

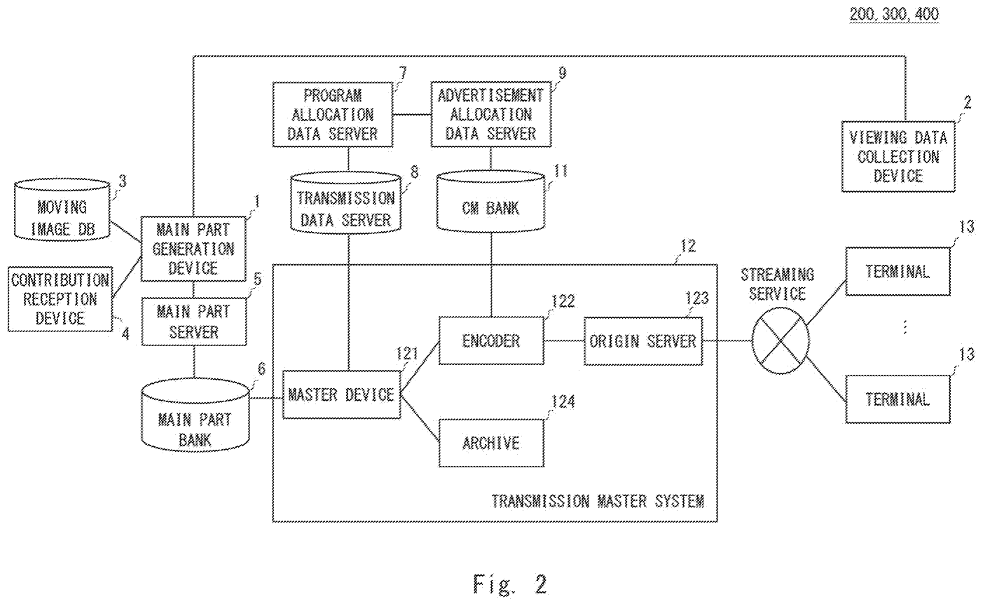

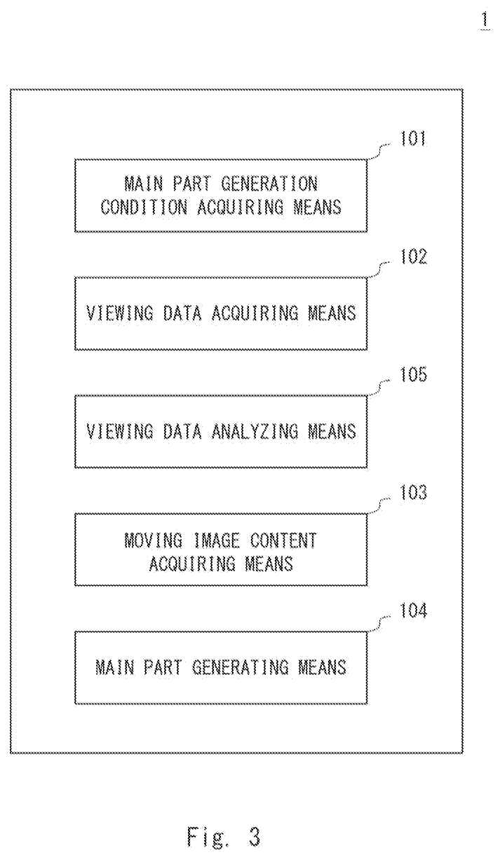

Subsequently, a configuration of a broadcast system 200 according to a second example embodiment is explained with reference to FIG. 2 and FIG. 3. The broadcast system 200 includes a main part generation device 1, a viewing data collection device 2, a moving image DB (database) 3, a contribution reception device 4, a main part server 5, a main part bank 6, a program allocation data server 7, a transmission data server 8, an advertisement allocation data server 9, a CM bank 11, a transmission master system 12, and a terminal 13. The main part generation device 1 according to the second example embodiment specifically illustrates the main part generation device 1 according to the first example embodiment.

The viewing data collection device 2 collects viewing-related data of the viewer from the terminal 13. The viewing-related data is, for example, viewing history data or viewer attribute data. The viewing attribute data is attribute data such as gender, a birth year, and a residential place of the viewer. The viewing history data indicates a genre of content viewed by the viewer and history data in a viewing time of the content of the viewer. The viewing-related data is viewer action data relating to the viewing history data or the viewer attribute data. The viewer action data is data indicating an action such as a purchase action of the viewer.

The main part generation device 1 includes main part generation condition acquiring means 101, viewing data acquiring means 102, moving image content acquiring means 103, main part generating means 104, and viewing data analyzing means 105 and is installed in a virtual space on the cloud.

The main part generation condition acquiring means 101 acquires main part generation condition data from a storage area of the own device. Here, the main part generation condition data indicates a generation condition for a main part program from a program production department of a broadcast station or the like and includes a genre of the main part program or length of the main part program. Here, the genre indicates a classification of a moving image such as gourmet, travel, movie, or game. The genre of the main part program may include genres at a plurality of levels. For example, the genres at the plurality of levels indicate hierarchized genres and indicate that, for example, a genre of overseas travel and a genre of domestic travel are included in a hierarchy immediately below the genre of travel. The genres at the plurality of levels indicate that a plurality of genres are present in the same hierarchy and indicates that, for example, the genre of gourmet and the genre of travel exist in the same hierarchy. When the genre of the main part program corresponds to both of the genre of gourmet and the genre of travel, the genre of the main part program may include a plurality of genres at the same hierarchy.

The viewing data acquiring means 102 acquires viewing-related data of the viewer from the viewing data collection device 2.

The moving image content acquiring means 103 acquires moving image content from a moving image DB 3. Here, metadata indicating an attribute of the moving image content is linked with the moving image content. The metadata includes a genre of a moving image. The moving image content acquiring means 103 acquires the moving image content and contribution information linked with the moving image content from the contribution reception device 4. The contribution information includes a position and a date and time where and when the moving image content is contributed or information concerning a user who contributed the moving image content.

The viewing data analyzing means 105 analyzes a viewing tendency or preference of the viewer based on the viewing-related data and generates viewing analysis data, which is an analysis result. Note that the viewing data collection device 2 may generate viewing analysis data based on the viewing-related data and the viewing data analyzing means 105 may acquire viewing analysis data from the viewing data collection device 2.

Based on the viewing analysis data and the main part generation condition data, the main part generating means 104 combines the moving image content acquired by the moving image content acquiring means 103 to generate main part moving image content to be distributed to the viewer. Specifically, the main part generating means 104 combines moving image content to which metadata relating to the viewing-related data and the main part generation condition data is attached. For example, the main part generating means 104 combines moving image content including metadata to which a genre of a moving image relating to the genre of the main part program included in the main part generation condition data is attached. The main part generating means 104 selects, based on the main part generation condition data, candidates of moving image content to be combined and determines, based on the viewing-related data, moving image content to be combined from the selected candidates of the moving image content. Then, the main part generating means 104 supplies a main part file including the generated main part moving image content to the main part server 5. Here, the main part file may include an advertisement frame into which advertisement content explained below is inserted in addition to the main part moving image content.

The moving image DB 3 stores moving image content and metadata attached to the moving image content. The moving image DB 3 supplies the moving image content to be stored to the main part generation device 1.

The contribution reception device 4 receives a contribution of moving image content from a user such as a moving image creator and acquires a contributed moving image. Note that the contribution reception device 4 may receive moving image content only from a contracted moving image creator. Then, the contribution reception device 4 supplies the acquired moving image to the main part generation device 1.

The main part server 5 generates a main part file and supplies the main part file to the main part bank 6. The main part file is generated by, for example, moving image content produced by a broadcast station or an individual producer.

The main part bank 6 stores the main part file and supplies the stored main part file to the transmission master system 12.

The program allocation data server 7 generates program organization data and supplies the program organization data to the transmission data server 8. The program organization data is information indicating in which time period a program is organized and is, for example, a program guide indicating a schedule of a program to be broadcast. In the program organization data, a program frame is present and an advertisement frame into which an advertisement is inserted is present between a program frame and a program frame int which programs are inserted. In the program frame, a main part frame into which a main part is inserted is present and an advertisement frame is present between a main part frame and a main part frame. Here, the program allocation data server 7 allocates the main part file explained below to a main part frame of the program organization data. That is, the program allocation data server 7 associates the main part frame of the program organization data and identification information for identifying the main part file explained below. The program allocation data server 7 uses advertisement allocation information acquired from the advertisement allocation data server 9 and allocates advertisement content explained below to an advertisement frame of a program in the program organization data. That is, the program allocation data server 7 associates the advertisement frame of the program of the program organization data and identification information for identifying the advertisement content.

The transmission data server 8 acquires program organization data from the program allocation data server 7 and stores the program organization data. Then, the transmission data server 8 supplies the program organization data to the transmission master system 12.

The advertisement allocation data server 9 generates advertisement allocation information and supplies the advertisement allocation information to the CM bank 11. The advertisement allocation information is information indicating what kind of advertisement content is allocated to the advertisement frame of the program. The advertisement allocation data server 9 supplies the advertisement allocation information to the program allocation data server 7.

The CM bank 11 stores advertisement content and supplies the advertisement content to the transmission master system 12. The advertisement content indicates content of an advertisement that is inserted before and after the program or halfway in the program and distributed to the viewers.

The transmission master system 12 includes a master device 121, an encoder 122, an origin server 123, and an archive 124 and is installed in a virtual space on the cloud.

The master device 121 acquires a main part file from the main part bank 6. The master device 121 acquires program organization data from the transmission data server 8.

The master device 121 generates program content using the main part file acquired from the main part bank 6 and the program organization data acquired from the transmission data server 8. Specifically, the master device 121 combines main part files according to the program organization data to generate a program content including the main part files and an advertisement frame into which an advertisement is inserted. Then, the master device 121 acquires viewing broadcast station information indicating a broadcast station to be viewed from the terminal 13 and supplies program content corresponding to the viewing broadcast station information to the encoder 122.

The encoder 122 generates content to be transmitted to the viewer using the advertisement content acquired from the CM bank 11 and the program content acquired from the master device 121. Specifically, the encoder 122 inserts advertisement content corresponding to an advertisement frame included in the program content into the content. Then, the encoder 122 performs encoding such as a change of a data format and compression of the content and supplies the encoded content to the origin server 123.

The origin server 123 acquires the encoded content from the encoder 122. The origin server 123 transmits the content to the terminal 13 of the viewer via a network such as the Internet. The origin server 123 transmits, for example, the content to the terminal 13 by streaming. The origin server 123 may store the acquired content.

The archive 124 stores content acquired from the master device 121. The stored content is used for, for example, a VOD (Video On Demand) service.

The terminal 13 is a mobile terminal such as a smartphone or a tablet or a stationary terminal such as a TV or a PC (Personal Computer). The terminal 13 acquires content from the origin server 123 of the transmission master system 12 by streaming. For example, the terminal 13 includes a dedicated application and, when the application is started, outputs a list of broadcast stations to which content can be distributed, when a broadcast station is selected by the user, acquires content corresponding to the broadcast station from the origin server 123, and outputs the content to a display.

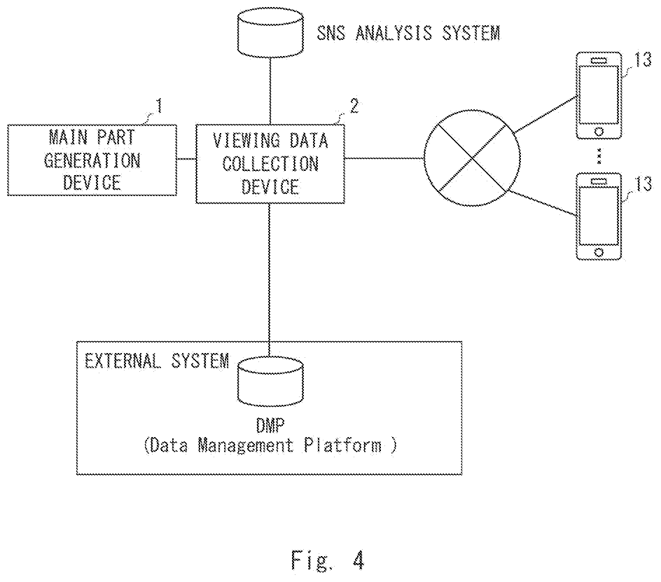

Subsequently, an operation of the viewing data collection device 2 according to the second example embodiment is explained with reference to FIG. 4.

As illustrated in FIG. 4, the viewing data collection device 2 acquires viewing history data and viewer attribute data as viewing-related data from the terminal 13. The viewing attribute data is attribute data such as gender, a birth year, and a residential place of the viewer. For example, a simultaneous distribution application for viewing of simultaneous distribution is installed in the terminal 13. The viewing data collection device 2 uses an application for viewing distribution in the terminal 13 and acquires viewing attribute data obtained by the viewer answering a questionnaire at the time of installing the application. The viewing history data indicates a genre of content viewed by the viewer and history data of a viewing time of the content of the viewer. For example, the viewing data collection device 2 stores viewing history data of the viewer together with a viewer ID, an application ID, or an advertisement ID in a log server at the time of viewing of the content by the viewer in the terminal 13.

The viewing data collection device 2 may acquire, as viewing-related data, viewer action data obtained by a panel analysis from an SNS (Social networking service) analysis system or a DMP (Data Management Platform) connected to the outside. The viewer action data indicates an action of the viewer of the terminal 13.

Then, the viewing data collection device 2 supplies the acquired viewing-related data to the main part generation device 1.

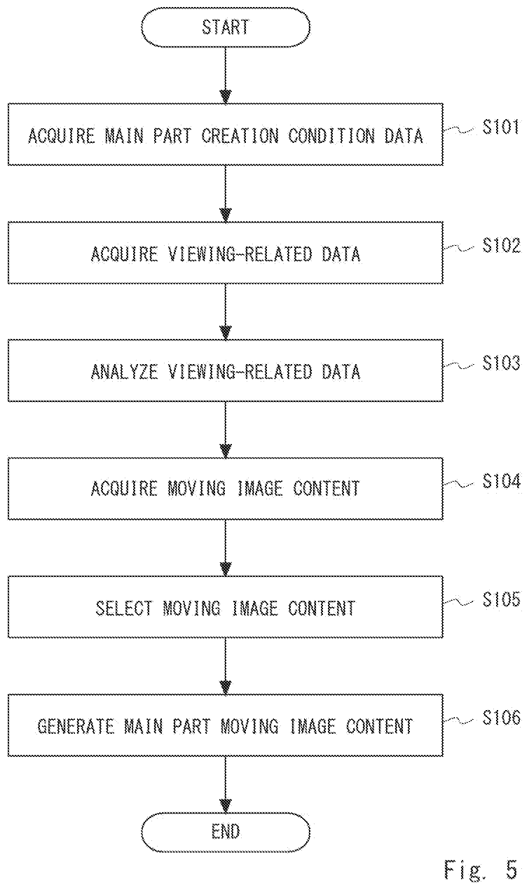

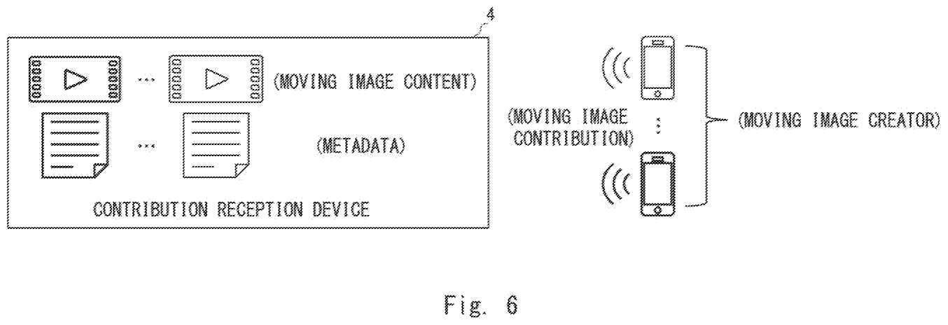

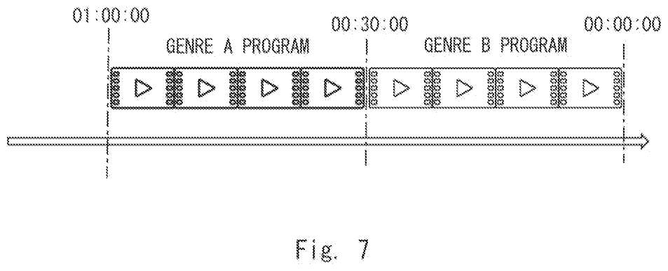

Subsequently, an operation of the viewing data collection device 2 according to the second example embodiment is explained with reference to FIG. 5 to FIG. 7. In the following explanation, FIG. 5 is mainly referred to but FIG. 6 or FIG. 7 is referred to as appropriate.

First, as illustrated in FIG. 5, the main part generation condition acquiring means 101 acquires main part generation condition data (step S101). The main part generation condition data indicates a generation condition for a main part program from a program production department of a broadcast station or the like and includes a genre of the main part program or length of the main part program.

Subsequently, the viewing data acquiring means 102 acquires viewing-related data of the viewer from the viewing data collection device 2 (step S102). Subsequently, the viewing data analyzing means 105 analyzes a viewing tendency or preference of the viewer based on the viewing-related data and generates viewing analysis data, which is an analysis result (step S103).

Subsequently, the moving image content acquiring means 103 acquires moving image content from the moving image DB 3 or the contribution reception device 4. For example, as illustrated in FIG. 6, the contribution reception device 4 receives a contribution of moving image content from a terminal of a user such as a video creator and acquires a contributed moving image. Then, the moving image content acquiring means 103 acquires the moving image content from the contribution reception device 4. Here, metadata indicating an attribute of the moving image content is attached to the moving image content. The metadata includes a genre of a moving image. The contribution information includes a position and a date and time where and when the moving image content is contributed or information concerning a user who contributed the moving image content.

Subsequently, the main part generating means 104 selects moving image content from the acquired moving image content based on the viewing analysis data and the main part generation condition data (step S105). Specifically, the main part generating means 104 selects, based on the main part generation condition data, candidates of moving image content to be combined and determines, based on the viewing-related data, the moving image content to be combined from the selected candidates of the moving image content. Here, the main part generating means 104 determines a plurality of pieces of moving image content to be combined. For example, the main part generating means 104 selects moving image content including metadata to which a genre of a moving image relating to a genre of a main part program included in the main part generation condition data is attached. Then, the main part generating means 104 determines, from the selected moving image content, moving image content including metadata to which a genre of a moving image relating to a genre matching the viewing tendency or preference of the viewer included in the viewing analysis data is added. Here, when genres at a plurality of levels are described in the metadata, the main part generating means 104 may select or determine moving image content according to priority order of genres.

Note that the main part generating means 104 may select, based on the viewing-related data, candidates of moving image content to be combined and determine, based on the main part generation condition data, the moving image content to be combined from the selected candidates of the moving image content. The main part generating means 104 may determine, based on the viewing-related data or the main part generation condition data, the moving image content to be combined.

The main part generating means 104 may determine the moving image content according to length of a main part program. Here, the main part generating means 104 determines the length of the main part program referring to the main part generation condition data. For example, when the length of the main part program is 30 minutes, the main part generating means 104 determines two types of moving image content for 10 minutes and two types of moving image content for 5 minutes to fit in the main part program for 30 minutes.

Subsequently, the main part generating means 104 generates main part moving image content using the selected moving image content (step S106). Specifically, as illustrated in FIG. 7, the main part generating means 104 combines the moving image content included in the selected moving image content to generate the main part moving image content. First, the main part generating means 104 sets length of a main part program to be generated. Here, the main part generating means 104 determines the length of the main part program referring to length of the main part program included in the main part generation condition data. Then, the main part generating means 104 combines the moving image content to fit within the length of the main part program. For example, the main part generating means 104 sets length of 30 minutes as a genre A program. Then, the main part generating means 104 combines the moving image content related to the genre A so as to fall within the length of the genre A program.

Note that the main part generating means 104 may similarly generate a genre B program for 30 minutes and combine the genre A program and the genre B program to generate a program for 60 minutes. When the length of the main part program remains even if the moving image content is combined, the main part generating means 104 may fill the remaining length of the main part program with a station logo or the like.

Then, the program generated by combining the moving image content with the main part generating means 104 is the main part moving image content. The main part generating means 104 supplies a main part file including the generated main part moving image content to the transmission master system 12.

Therefore, the broadcast system 200 according to the second example embodiment generates the main part moving image content using the main part generation condition data indicating, for example, requirements of the broadcast station. Accordingly, the broadcast system 200 can reflect requirements on a program broadcast side such as the requirements of the broadcast station on the production of the program.

The broadcast system 200 generates a main part moving image content using viewing analysis data indicating a viewing tendency and preference of the viewer. Accordingly, the broadcast system 200 can reflect the viewing tendency and preference of the viewer on production of a program and generate an optimum program matching the viewer.

The broadcast system 200 combines moving image content matching a genre of a program to automatically generate main part program data. Accordingly, the broadcast system 200 can improve the efficiency of generation of the main part program. For example, the broadcast system 200 can simplify many processes required for generating a main part program and can realize significant efficiency improvement of personnel required for generating the main part program.

The broadcast system 200 includes means for receiving a contribution moving image from a user such as a moving image creator. Here, in program production, not only a moving image generated by a broadcast station but also a contributed moving image from a user such as a moving image creator is increasingly used. The broadcast system 200 can cope with the moving image and the contributed moving image.

### Third Example Embodiment

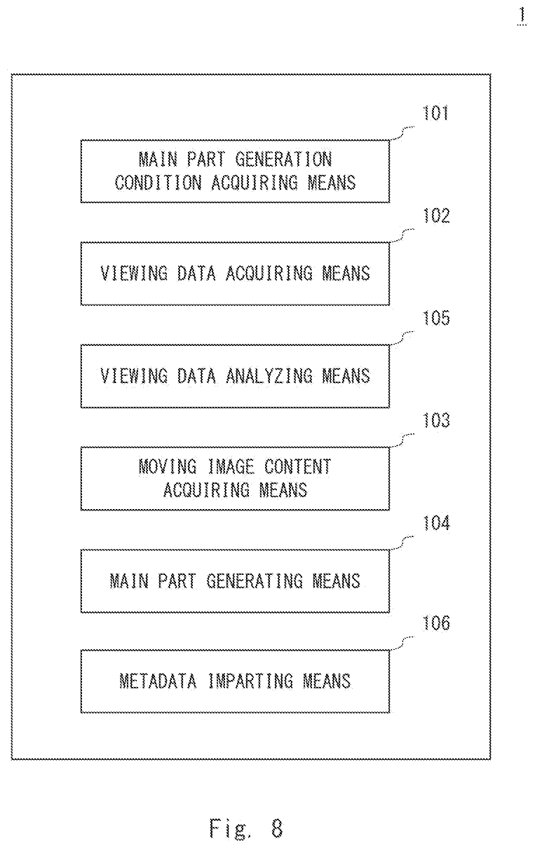

Subsequently, a configuration of a broadcast system 300 according to a third example embodiment is explained with reference to FIG. 2 and FIG. 8. The broadcast system 300 according to the third example embodiment is different from the broadcast system 200 according to the second example embodiment in that the following configuration is added.

The main part generation device 1 according to the third example embodiment further includes metadata imparting means 106. The metadata imparting means 106 analyzes the moving image content and imparts metadata to the moving image content. Specifically, the metadata imparting means 106 imparts the metadata based on a recognition result of an image included in the moving image content, an extraction result of text from the moving image content, or a recognition result of voice included in the moving image content. In addition, the metadata imparting means 106 may impart the metadata based on contribution information acquired from the contribution reception device 4. The contribution information includes a position and a date and time where and when the moving image content is contributed or information concerning a user who contributed the moving image content.

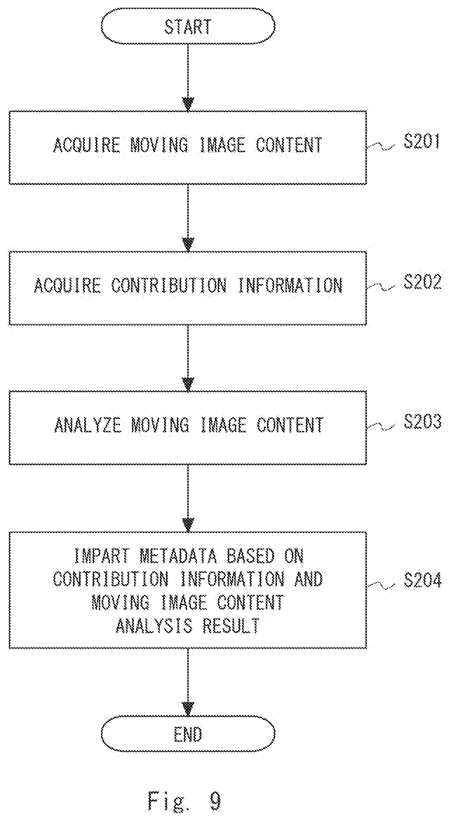

Subsequently, an operation of the main part generation device 1 according to the third example embodiment is explained with reference to FIG. 9.

First, the metadata imparting means 106 acquires moving image content from the contribution reception device 4 (step S201). The metadata imparting means 106 may acquire the moving image content from the moving image DB 3. Subsequently, the metadata imparting means 106 acquires contribution information from the contribution reception device 4 (step S202).

Subsequently, the metadata imparting means 106 analyzes the moving image content (step S203). Specifically, the metadata imparting means 106 analyzes the moving image content and recognizes a person, an object, or a background included in the moving image content. The metadata imparting means 106 analyzes the moving image content and extracts text included in the moving image content. The metadata imparting means 106 analyzes voice data included in the moving image content and recognizes voice included in the moving image content. In the following explanation, a recognition result of an image included in the moving image content, an extraction result of the text from the moving image content, or a recognition result of the voice data included in the moving image content is referred to as a moving image content analysis result.

Subsequently, the metadata imparting means 106 imparts metadata to the moving image content based on the contribution information and the moving image content analysis result (step S204). Specifically, the metadata imparting means 106 estimates metadata from the contribution information and the moving image content analysis result and imparts the estimated metadata to the moving image content. For example, the metadata imparting means 106 estimates a genre of a moving image from the contribution information and the image analysis result and imparts the estimated genre to the moving image content as metadata. Note that the metadata imparting means 106 may estimate candidates of metadata of a plurality of images in images included in the moving image content using the contribution information and the moving image content analysis result and impart metadata corresponding to a largest number of images among the estimated metadata.

The broadcast system 300 according to the third example embodiment achieves the same effects as the effects of the broadcast system 200 according to the second example embodiment.

The broadcast system 300 according to the third example embodiment automatically imparts metadata to the moving image content by analyzing the moving image content. The broadcast system 300 can omit a process in which a person imparts metadata to the moving image content. Accordingly, the broadcast system 300 can make the moving image collection to the program production efficient.

### Fourth Example Embodiment

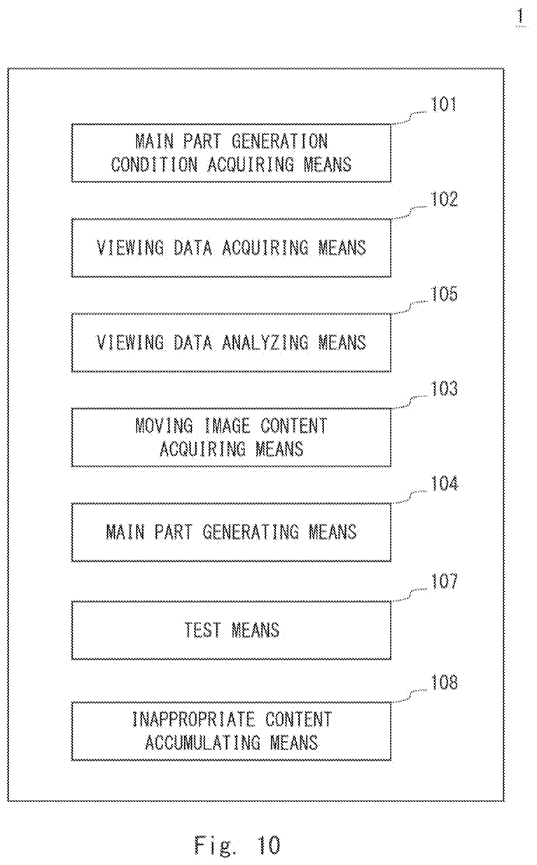

Subsequently, a configuration of a broadcast system 400 according to a fourth example embodiment is explained with reference to FIG. 2 and FIG. 10. The broadcast system 400 according to the fourth example embodiment is different from the broadcast system 200 according to the second example embodiment in that the following configuration is added.

The main part generation device 1 according to the fourth example embodiment further includes test means 107 and inappropriate content accumulating means 108.

The test means 107 tests content of generated main part moving image content. Specifically, the test means 107 tests the content based on a recognition result of an image included in the main part moving image content, an extraction result of text from the main part moving image content, or a recognition result of voice included in the main part moving image content. Here, the test means 107 tests the content according to comparison of the recognition result of the image, the extraction result of the text, or the recognition result of the voice and the information accumulated by the inappropriate content accumulating means 108.

The inappropriate content accumulating means 108 accumulates inappropriate content. The inappropriate content indicates data such as information concerning image, text, or voice inappropriate for broadcast.

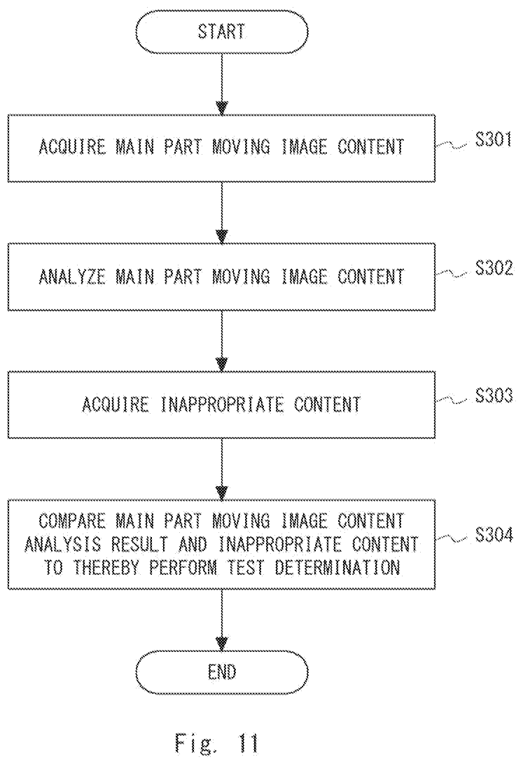

Subsequently, an operation of the main part generation device 1 according to the third example embodiment is explained with reference to FIG. 11.

First, the test means 107 acquires the main part moving image content generated by the main part generating means 104 (step S301). Note that the test means 107 may acquire moving image content from the moving image DB 3.

Subsequently, the test means 107 analyzes the acquired main part moving image content (step S302). Specifically, the test means 107 analyzes the main part moving image content and recognizes a person, an object, or a background included in the main part moving image content. The test means 107 analyzes the main part moving image content and extracts text included in the main part moving image content. The test means 107 analyzes voice data included in the main part moving image content and recognizes voice included in the main part moving image content. In the following explanation, the recognition result of the image included in the main part moving image content, the extraction result of the text from the main part moving image content, or the recognition result of the voice data included in the main part moving image content is referred to as main part moving image content analysis result.

Subsequently, the test means 107 acquires inappropriate content from the inappropriate content accumulating means 108 (step S303).

Subsequently, the test means 107 compares the main part moving image content analysis result and the inappropriate content accumulated by the inappropriate content accumulating means 108 to thereby perform test determination (step S304). For example, when content similar to inappropriate content is included in the main part moving image content analysis result by a predetermined threshold or more, the test means 107 determines that the main part moving image content is inappropriate data. Note that the test means 107 may test the content of the main part moving image content according to test criteria of a broadcast station or a program producer.

The broadcast system 400 according to the fourth example embodiment achieves the same effects as the effects of the broadcast system 200 according to the second example embodiment.

The broadcast system 400 analyzes the moving image content to thereby automatically test the moving image content. Therefore, the broadcast system 400 can omit a process in which a person tests the moving image content. Therefore, the broadcast system 400 can efficiently transmit a safe program to the viewer.

Note that the present invention is not limited to the example embodiments explained above and can be changed as appropriate without departing from the scope of the present invention.

For example, in the broadcast system 300 according to the third example embodiment, the metadata imparting means 106 of the main part generation device 1 may not be included in the main part generation device 1 and may be independently installed as a device outside the main part generation device 1.

In the broadcast system 400 according to the fourth example embodiment, the main part generation device 1 may include the metadata imparting means 106 according to the third example embodiment. In the broadcast system 400, the test means 107 or the inappropriate content accumulating means 108 may not be included in the main part generation device 1 but may be independently installed as a device outside the main part generation device 1.

### <Hardware Configuration>

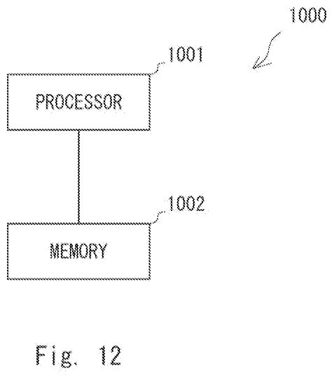

Subsequently, a hardware configuration example of the computer 1000 relating to the devices (for example, the main part generation device 1) configuring the main part generation device 1, the broadcast system 200, the broadcast system 300, and the broadcast system 400 is explained with reference to FIG. 12. In FIG. 12, the computer 1000 includes a processor 1001 and a memory 1002. The processor 1001 may be, for example, a microprocessor, an MPU (Micro Processing Unit), or a CPU (Central Processing Unit). The processor 1001 may include a plurality of processors. The memory 1002 is configured by a combination of a volatile memory and a nonvolatile memory. The memory 1002 may include a storage disposed away from the processor 1001. In this case, the processor 1001 may access the memory 1002 via a not-illustrated I/O interface.

The devices in the example embodiments explained above may be configured by hardware, software, or both, may be configured by one piece of hardware or software, or may be configured by a plurality of pieces of hardware or software. The functions (the processing) of the devices in the example embodiments explained above may be realized by a computer. For example, programs for performing the methods in the example embodiments may be stored in the memory 1002 and the functions may be realized by the processor 1001 executing the programs stored in the memory 1002.

The programs explained above can be stored and supplied to the computer using various types of non-transitory computer-readable media. The non-transitory computer-readable media include various types of tangible storage media. Examples of non-transitory computer-readable medium include a magnetic recording medium (for example, a flexible disk, a magnetic tape, or a hard disk drive), a magneto-optical recording medium (for example, a magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (random Access memory)). The programs may be supplied to the computer through various types of transitory computer-readable media. Examples of the transitory computer-readable media include electrical signals, optical signals, and electromagnetic waves. The transitory computer-readable media can supply the programs to the computer via wired or wireless communication paths such as wires and optical fiber.

A part or all of the example embodiments explained above can be explained as in the following supplementary notes but are not limited to the following supplementary notes.

### (Supplementary Note 1)

A main part generation device including:
main part generation condition acquiring means for acquiring main part generation condition data indicating a generation condition for a main part program of a broadcast station;
viewing data acquiring means for acquiring viewing-related data of a viewer from a terminal device with which the viewer views main part moving image content;
moving image acquiring means for acquiring a plurality of pieces of moving image content; and
main part generating means for generating, based on the viewing-related data and the main part generation condition data, main part moving image content to be distributed to the viewer by combining the moving image content.

### (Supplementary Note 2)

The main part generation device described in Supplementary note 1, wherein the main part generating means selects, based on the main part generation condition data, candidates of the moving image content to be combined and determines, based on the viewing-related data, moving image content to be combined from the selected candidates of the moving image content.

### (Supplementary Note 3)

The main part generation device described in Supplementary note 1 or 2, wherein the main part generation condition data includes a genre of the main part program or length of the main part program.

### (Supplementary Note 4)

The main part generation device described in Supplementary note 3, wherein the genre includes genres at a plurality of levels.

### (Supplementary Note 5)

The main part generation device described in any one of Supplementary notes 1 to 4, wherein
metadata indicating an attribute of the moving image content is imparted to the moving image content, and
the main part generating means combines the moving image content to which the attribute relating to the viewing-related data and the main part generation condition data is imparted.

### (Supplementary Note 6)

The main part generation device described in Supplementary note 5, wherein the attribute includes a genre of the moving image content.

### (Supplementary Note 7)

The main part generation device described in Supplementary note 6, wherein a genre of the moving image content corresponds to a genre of the main part program included in the main part generation condition data.

### (Supplementary Note 8)

The main part generation device described in any one of Supplementary notes 5 to 7, further including metadata imparting means for analyzing the moving image content and imparting the metadata to the moving image content based on an analysis result of the moving image content.

### (Supplementary Note 9)

The main part generation device described in Supplementary note 8, wherein the metadata imparting means analyzes the moving image content and imparts the metadata based on a recognition result of an image included in the moving image content, an extraction result of text from the moving image content, or a recognition result of voice included in the moving image content.

### (Supplementary Note 10)

The main part generation device described in Supplementary note 8 or 9, wherein the metadata imparting means estimates candidates of a plurality of pieces of metadata in images included in the moving image content and imparts metadata corresponding to a largest number of images among the estimated metadata to the moving image content.

### (Supplementary Note 11)

The main part generation device described in any one of Supplementary notes 8 to 10, wherein
the moving image acquiring means acquires contribution information of the moving image content together with the moving image content, and
the metadata imparting means imparts the metadata to the moving image content based on the contribution information.

### (Supplementary Note 12)

The main part generation device described in Supplementary note 11, wherein the contribution information includes a position and a date and time where and when the moving image content is contributed or information concerning a user.

### (Supplementary Note 13)

The main part generation device described in any one of Supplementary notes 1 to 12, further including analyzing means for analyzing a viewing tendency or preference of the viewer based on the viewing-related data,
wherein the main part generating means combines the moving image content according to a result of the analysis

### (Supplementary Note 14)

The main part generation device described in any one of Supplementary notes 1 to 13, wherein the viewing-related data includes viewing history data or viewer attribute data of the viewer.

### (Supplementary Note 15)

The main part generation device described in Supplementary note 14, wherein the viewing-related data includes viewer action data relating to the viewing history data or the viewer attribute data.

### (Supplementary Note 16)

The main part generation device described in any one of Supplementary notes 1 to 15, further including test means for testing content of the generated main part moving image content.

### (Supplementary Note 17)

The main part generation device described in Supplementary note 16, wherein the test means tests the content based on a recognition result of an image included in the main part moving image content, an extraction result of text from the main part moving image content, or a recognition result of voice included in the main part moving image content.

### (Supplementary Note 18)

The main part generation device described in supplementary note 17, further including inappropriate content accumulating means for accumulating information concerning an image, text, or voice inappropriate for broadcast,
wherein the test means tests the content according to comparison of a recognition result of the image, an extraction result of the text, or a recognition result of the voice and the accumulated information.

### (Supplementary Note 19)

The main part generation device described in any one of Supplementary notes 16 to 18, wherein the test means tests images of the main part moving image content and determines a test result of the main part moving image content based on a test result of the images.

### (Supplementary Note 20)

The main part generation device described in any one of Supplementary notes 16 to 19, wherein the test means tests the content of the main part moving image content according to test criteria of the broadcast station.

### (Supplementary Note 21)

The main part generation device described in any one of Supplementary notes 1 to 20, wherein the main part generation device is disposed in a virtual environment on a cloud.

### (Supplementary Note 22)

A main part generation method including:
acquiring main part generation condition data indicating a generation condition for a main part program of a broadcast station;
acquiring viewing-related data of a viewer from a terminal device with which the viewer views main part moving image content;
acquiring a plurality of pieces of moving image content; and
generating, based on the viewing-related data and the main part generation condition data, main part moving image content to be distributed to the viewer by combining the moving image content.

### (Supplementary Note 23)

A non-transitory computer-readable medium storing a program for causing a computer to execute processing for:
acquiring main part generation condition data indicating a generation condition for a main part program of a broadcast station;
acquiring viewing-related data of a viewer from a terminal device with which the viewer views main part moving image content;
acquiring a plurality of pieces of moving image content; and
generating, based on the viewing-related data and the main part generation condition data, main part moving image content to be distributed to the viewer by combining the moving image content.

### REFERENCE SIGNS LIST

1 MAIN PART GENERATION DEVICE
2 VIEWING DATA COLLECTION DEVICE
3 MOVING IMAGE DB
4 CONTRIBUTION RECEPTION DEVICE
5 MAIN PART SERVER
6 MAIN PART BANK
7 PROGRAM ALLOCATION DATA SERVER
8 TRANSMISSION DATA SERVER
9 ADVERTISEMENT ALLOCATION DATA SERVER
11 CM BANK
12 TRANSMISSION MASTER SYSTEM
13 TERMINAL
101 MAIN PART GENERATION CONDITION ACQUIRING MEANS
102 VIEWING DATA ACQUIRING MEANS
103 MOVING IMAGE CONTENT ACQUIRING MEANS
104 MAIN PART GENERATING MEANS
105 VIEWING DATA ANALYZING MEANS
106 METADATA IMPARTING MEANS
107 TEST MEANS
108 INAPPROPRIATE CONTENT ACCUMULATING MEANS
121 MASTER DEVICE
122 ENCODER
123 ORIGIN SERVER
124 ARCHIVE
200 BROADCAST SYSTEM
300 BROADCAST SYSTEM
400 BROADCAST SYSTEM
1000 COMPUTER
1001 PROCESSOR
1002 MEMORY

What is claimed is:

1. A main part generation device comprising:
at least one memory that is configured to store instructions; and
at least one processor that is configured to execute the instructions to:
main part generation condition acquiring means for acquiring acquire main part generation condition data indicating a generation condition for a main part program of a broadcast station;
acquire viewing-related data of a viewer from a terminal device with which the viewer views main part moving image content;
acquire a plurality of pieces of moving image content; and
generate, based on the viewing-related data and the main part generation condition data, main part moving image content to be distributed to the viewer by combining the moving image content.

2. The main part generation device according to claim 1, wherein the at least one processor that is configured to execute the instructions to select, based on the main part generation condition data, candidates of the moving image content to be combined and determines, based on the viewing-related data, moving image content to be combined from the selected candidates of the moving image content.

3. The main part generation device according to claim 1, wherein the main part generation condition data includes a genre of the main part program or length of the main part program.

4. The main part generation device according to claim 3, wherein the genre includes genres at a plurality of levels.

5. The main part generation device according to claim 1, wherein
metadata indicating an attribute of the moving image content is imparted to the moving image content, and
the at least one processor that is configured to execute the instructions to combine the moving image content to which the attribute relating to the viewing-related data and the main part generation condition data is imparted.

6. The main part generation device according to claim 5, wherein the attribute includes a genre of the moving image content.

7. The main part generation device according to claim 6, wherein a genre of the moving image content corresponds to a genre of the main part program included in the main part generation condition data.

8. The main part generation device according to claim 5, further comprising metadata imparting means for analyzing wherein the at least one processor that is configured to execute the instructions to analyze the moving image content and imparting impart the metadata to the moving image content based on an analysis result of the moving image content.

9. The main part generation device according to claim 8, wherein the at least one processor that is configured to execute the instructions to analyze the moving image content and impart the metadata based on a recognition result of an image included in the moving image content, an extraction result of text from the moving image content, or a recognition result of voice included in the moving image content.

10. The main part generation device according to claim 8, wherein the at least one processor that is configured to execute the instructions to estimate candidates of a plurality of pieces of metadata in images included in the moving image content and impart metadata corresponding to a largest number of images among the estimated metadata to the moving image content.

11. The main part generation device according to claim 8, wherein the at least one processor that is configured to execute the instructions to:
acquire contribution information of the moving image content together with the moving image content; and
impart the metadata to the moving image content based on the contribution information.

12. The main part generation device according to claim 11, wherein the contribution information includes a position and a date and time where and when the moving image content is contributed or information concerning a user.

13. The main part generation device according to claim 1 wherein further comprising analyzing means for analyzing the at least one processor that is configured to execute the instructions to analyze a viewing tendency or preference of the viewer based on the viewing-related data,
wherein the at least one processor that is configured to execute the instructions to combine the moving image content according to a result of the analysis.

14. The main part generation device according to claim 1, wherein the viewing-related data includes viewing history data or viewer attribute data of the viewer.

15. The main part generation device according to claim 14, wherein the viewing-related data includes viewer action data relating to the viewing history data or the viewer attribute data.

16. The main part generation device according to claim 1, wherein the at least one processor that is configured to execute the instructions to test content of the generated main part moving image content.

17. The main part generation device according to claim 16, wherein the wherein the at least one processor that is configured to execute the instructions to test the content based on a recognition result of an image included in the main part moving image content, an extraction result of text from the main part moving image content, or a recognition result of voice included in the main part moving image content.

18. The main part generation device according to claim 17, wherein the at least one processor that is configured to execute the instructions to accumulate information concerning an image, text, or voice inappropriate for broadcast,
wherein the at least one processor that is configured to execute the instructions to test the content according to comparison of a recognition result of the image, an extraction result of the text, or a recognition result of the voice and the accumulated information.

19-21. (canceled)

22. A main part generation method comprising:
acquiring main part generation condition data indicating a generation condition for a main part program of a broadcast station;
acquiring viewing-related data of a viewer from a terminal device with which the viewer views main part moving image content;
acquiring a plurality of pieces of moving image content; and
generating, based on the viewing-related data and the main part generation condition data, main part moving image content to be distributed to the viewer by combining the moving image content.

23. A non-transitory computer-readable medium storing a program for causing a computer to execute processing for:
acquiring main part generation condition data indicating a generation condition for a main part program of a broadcast station;
acquiring viewing-related data of a viewer from a terminal device with which the viewer views main part moving image content;
acquiring a plurality of pieces of moving image content; and
generating, based on the viewing-related data and the main part generation condition data, main part moving image content to be distributed to the viewer by combining the moving image content.
